(19) United States
(12) Patent Application Publication
(10) Pub. No.: US 2026/0228770 A1
(43) Pub. Date: Aug. 6, 2026

(54) SYSTEMS AND METHODS FOR CAMPAIGN MANAGEMENT

(71) Applicant: JPMORGAN CHASE BANK, N.A., New York, NY (US)

(72) Inventors: Flora CHUNG, Cresskill, NJ (US); Waylen ROCHE, Newburgh, NY (US); Anthony KELLY, Aliso Viejo, CA (US); Thomas BRESAN, Mount Laurel, NJ (US); Julia HARRINGTON, Palisades Park, NJ (US)

(21) Appl. No.: 19/532,668

(22) Filed: Feb. 6, 2026

Related U.S. Application Data
(60) Provisional application No. 63/754,954, filed on Feb. 6, 2025.

(51) Int. Cl. G06Q 30/0207; G06Q 50/18

(52) U.S. Cl. CPC G06Q 30/0219; G06Q 50/184

(57) ABSTRACT

Systems and methods for campaign management are disclosed. A method may include: receiving, by a computer program executed by an electronic device, campaign parameters and a campaign budget for a campaign from a user for a merchant; generating, by the computer program, an offer for the campaign using the campaign parameters and merchant information; identifying, by the computer program, a target geography for the campaign; identifying, by the computer program, targeted customers in the target geography; populating, by the computer program, an offer section in a website presented to the targeted customers with the offer for the campaign; monitoring, by the computer program, a progress of the campaign; dynamically updating, by the computer program, the target geography based on the progress of the campaign; and terminating, by the computer program, the campaign in response to a campaign term ending or one of the campaign parameters being met.

### RELATED APPLICATIONS

This application claims priority to, and the benefit of, U.S. Provisional Patent Application Ser. No. 63/754,954, filed February 6, 2025, the disclosure of which is hereby incorporated, by reference, in its entirety.

### BACKGROUND OF THE INVENTION

### 1. Field of the Invention

Embodiments relate to systems and methods for campaign management.

### 2. Description of the Related Art

Running a campaign, such as offering discounts, to incentivize business is difficult, and has many unknowns. Small businesses generally do not have the resources to create and manage such card-linked offer campaigns on their own.

### SUMMARY OF THE INVENTION

Systems and methods for campaign management are disclosed. According to an embodiment, a method may include: receiving, by a computer program executed by an electronic device, campaign parameters and a campaign budget for a campaign from a user for a merchant; generating, by the computer program, an offer for the campaign using the campaign parameters and merchant information; identifying, by the computer program, a target geography for the campaign; identifying, by the computer program, targeted customers in the target geography; populating, by the computer program, an offer section in a website presented to the targeted customers with the offer for the campaign; monitoring, by the computer program, a progress of the campaign; dynamically updating, by the computer program, the target geography based on the progress of the campaign; and terminating, by the computer program, the campaign in response to a campaign term ending or one of the campaign parameters being met.

In an embodiment, the campaign parameters comprise a length of the campaign, an inventive, a minimum spend amount, and a maximum incentive amount.

In an embodiment, the method may also include: receiving, by the computer program, imagery for the campaign from the user; verifying, by the computer program and using an artificial intelligence (AI) agent, that the imagery is not offensive and does not have copyright or trademark issues; and in response to the imagery being not offensive and not having copyright or trademark issues, using the imagery in the campaign.

In an embodiment, the method may also include generating, by the computer program and using a marketing AI agent, imagery for the campaign using the campaign parameters and the merchant information.

In an embodiment, the step of generating the offer for the campaign using the campaign parameters and merchant information may include: identifying, by the computer program, an incentive structure that has been successful from a database of historical campaign data for similar merchants; and updating, by the computer program, the campaign parameters based on the incentive structure.

In an embodiment, the step of identifying the target geography for the campaign may include: calculating, by the computer program, a search radius based on a merchant location and a population density; and automatically adding or excluding, by the computer program, customer areas based on historical activation rates and historical redemption rates.

In an embodiment, the step of identifying the targeted customers in the target geography may include: identifying customers with transaction patterns matching a use case specified by the user.

In an embodiment, the step of monitoring the progress of the campaign may include receiving, by the computer program, information on offer views, offer activations, and offer redemptions.

In an embodiment, the step of dynamically updating the target geography based on the progress of the campaign may include dynamically refining, by the computer program, the target geography by adding or removing customer areas based on offer views, offer activations, and offer redemptions in the customer areas.

According to another embodiment, a system may include: a computer program executed by a backend electronic device; a merchant computer program executed by a merchant electronic device for a merchant; and a user electronic device executing a user computer program. The computer program may be configured to receive from the merchant computer program, campaign parameters and a campaign budget for a campaign from a user for a merchant; the computer program may be configured to generate an offer for the campaign using the campaign parameters and merchant information; the computer program may be configured to identify a target geography for the campaign; the computer program may be configured to identify targeted customers in the target geography; the computer program may be configured to identify populate an offer section in in the user computer program with the offer for the campaign; the computer program may be configured to monitor a progress of the campaign; the computer program may be configured to dynamically update the target geography based on the progress of the campaign; and the computer program may be configured to terminate the campaign in response to a campaign term ending or one of the campaign parameters being met.

In an embodiment, the campaign parameters comprise a length of the campaign, an inventive, a minimum spend amount, and a maximum incentive amount.

In an embodiment, the computer program may be further configured to receive imagery for the campaign from the user, to verify using an artificial intelligence (AI) agent, that the imagery is not offensive and does not have copyright or trademark issues, and, in response to the imagery being not offensive and not having copyright or trademark issues, use the imagery in the campaign.

In an embodiment, the computer program may be further configured to generate, using a marketing AI agent, imagery for the campaign using the campaign parameters and the merchant information.

In an embodiment, the computer program may be configured to generate the offer for the campaign using the campaign parameters and merchant information by: identifying an incentive structure that has been successful from a database of historical campaign data for similar merchants; and updating the campaign parameters based on the incentive structure.

In an embodiment, the computer program may be configured to identify the target geography for the campaign by: calculating a search radius based on a merchant location and a population density; and automatically adding or excluding customer areas based on historical activation rates and historical redemption rates.

In an embodiment, the computer program may be configured to identify the targeted customers in the target geography by identifying customers with transaction patterns matching a use case specified by the user.

In an embodiment, the computer program may be configured monitor the progress of the campaign by receiving information on offer views, offer activations, and offer redemptions.

In an embodiment, the computer program may be configured to dynamically update the target geography based on the progress of the campaign by dynamically refining the target geography by adding or removing customer areas based on offer views, offer activations, and offer redemptions in the customer areas.

According to another embodiment, a non-transitory computer readable storage medium may include instructions stored thereon, which when read and executed by one or more computer processors, cause the one or more computer processors to perform steps comprising: receiving campaign parameters and a campaign budget for a campaign from a user for a merchant, wherein the campaign parameters comprise a length of the campaign, an inventive, a minimum spend amount, and a maximum incentive amount; generating an offer for the campaign using the campaign parameters and merchant information by: identifying an incentive structure that has been successful from a database of historical campaign data for similar merchants; and updating the campaign parameters based on the incentive structure; identifying a target geography for the campaign; identifying targeted customers in the target geography by: calculating a search radius based on a merchant location and a population density; and automatically adding or excluding customer areas based on historical activation rates and historical redemption rates; populating an offer section in a website presented to the targeted customers with the offer for the campaign; monitoring a progress of the campaign by receiving information on offer views, offer activations, and offer redemptions; dynamically updating the target geography based on the progress of the campaign by dynamically refining the target geography by adding or removing customer areas based on offer views, offer activations, and offer redemptions in the customer areas; and terminating the campaign in response to a campaign term ending or one of the campaign parameters being met.

In an embodiment, the non-transitory computer readable storage medium may further include instructions stored thereon, which when read and executed by one or more computer processors, cause the one or more computer processors to perform steps comprising: receiving imagery for the campaign from the user; verifying, using an artificial intelligence (AI) agent, that the imagery is not offensive and does not have copyright or trademark issues; and in response to the imagery being not offensive and not having copyright or trademark issues, using the imagery in the campaign.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for campaign management according to an embodiment;

FIG. 2 illustrates a method for campaign management according to an embodiment; and

FIG. 3 depicts an exemplary computing system for implementing aspects of the present disclosure.

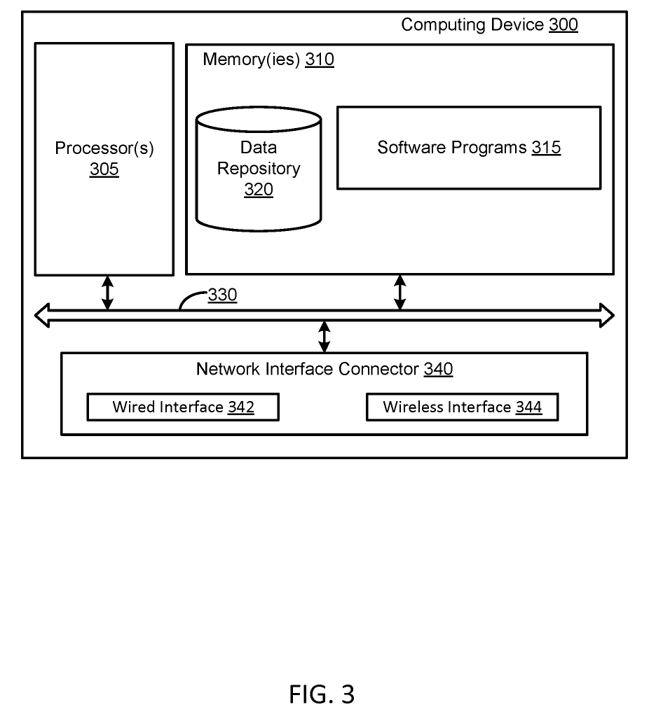

### DETAILED DESCRIPTION OF PREFERRED EMBODIMENTS

Embodiments are directed to systems and methods for campaign management.

Embodiments may provide a merchant interface where a merchant, such as an owner or an employee, may enter parameters for a campaign. For example, the merchant may enter a budget and cashback rate or discount, a limit on the cashback or discount, a minimum spend to be entitled to the cashback or discount, start and end dates for the campaign, imagery, locations, names of businesses categories of businesses using standardized industry codes customer may or may not have shopped at in a given period of time, etc. Using a database and a mathematical model, a computer program may recommend the most popular and optimal campaign parameters, such as budget, cashback percentage, minimum spend, and maximum cashback. These recommendations can help in predicting campaign costs, profits, and other key metrics.

Once the campaign is established, it may run on a financial institution’s website or mobile application as an offer to certain financial institution customers, such as to eligible credit card holders.

In one embodiment, the offer may be targeted to financial institution customers in a certain customer area, such as a certain ZIP code or metropolitan or micropolitan statistical identifier, within a certain distance of the merchant location. In one embodiment, depending on the success of the campaign, the size of the area may increase or decrease. For example, if the campaign is successful, the size of the area may decrease in order to stay within budget; if the campaign is not as successful, the size of the area may increase.

Embodiments may enhance the product by reaching more potential merchants and offering recommendations to make campaigns more successful. This includes features such as automatic budget management, merchant-transaction matching, and data-driven offer suggestions. It may provide the following: (1) automatically managing the budget by adjusting the target area size based on redemption trends: If activation rates are higher than expected, offers may be removed for inactive customers who activated the offer but did not make a purchase in the last X days, and the target area may be reduced to stay within budget. Conversely, if activation rates are lower than expected, the target area can be expanded to reach more potential customers; (2) automatically matching merchants to transactions at their stores from consumers; (3) automatically identifying merchants that can benefit from this based on changes in transaction activity and customer analyses; (4) automatically populating/suggesting offer approaches based on those same customer insight-like analyses (e.g., you should consider increasing both your cash back percentage and the maximum cash back amount, especially since your average order value (AOV) is high); (5) debiting the merchant daily (instead of weekly) to lower financial risk of receivables by the financial intuition; (6) end of date notifications to merchants of their activity to monitor campaign performance; etc.

In embodiments, the campaign may be presented next to a campaign for a similar and typically larger merchant. For example, if the merchant is a small restaurant (e.g., John’s Pizza), it may be presented next to a campaign for a chain restaurant in the offers section of the financial institution's credit card center website.

According to other embodiments, systems and methods for matching business banking customers to a financial institution are disclosed. For example, embodiments may be based on the principles of merchant matching and competitive targeting based on industry, credit card transaction strings, and comparable industry data.

Thus, embodiments reduce friction for the business banking customers by validating data about their merchant information through matching, rather than having the business banking customers entering minute details about their store and terminal details, change acquiring, etc.

For example, embodiments may use one or more of phone number matching, exact business name matching, and approximate business name matching to match merchants to existing business banking customers. Merchant category codes (MCCs) and geographical locations may also be used.

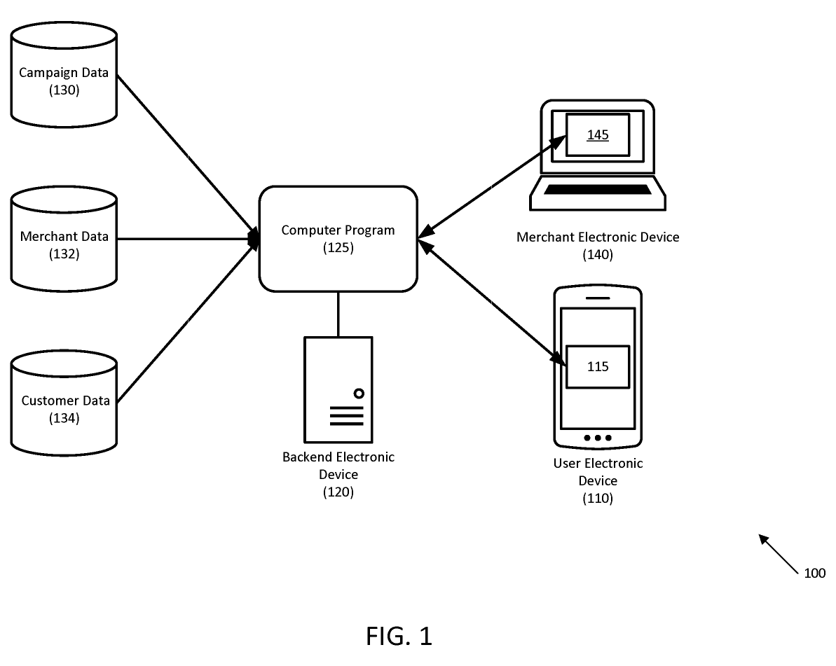

Referring to FIG. 1, a system for campaign management is provided according to an embodiment. System 100 may include merchant electronic device 140, which may be a computer (e.g., workstation, desktop, laptop, notebook, tablet, etc.), a smart device (e.g., a smart phone, a smart watch, etc.), an Internet of Things (IoT) appliance, etc. Merchant electronic device 140 may execute merchant computer program 145, which may interface with computer program 125 executed by backend electronic device 120.

Backend electronic device 120 may be a server (e.g., physical and/or cloud-based), a computer, etc. that may execute computer program 125. Computer program 125 may receive, from merchant computer program 145 for merchant , information for a new campaign, such as budget parameters and campaign parameters, and may generate a campaign using the parameters.

The merchant may be the owner or an employee of a merchant or other entity seeking to offer an incentive for purchasing or using its goods or services.

Backend electronic device 120 and computer program 125 may be provided by an entity, such as a financial institution, that may provide marketing services for its clients. The marketing services may include, for example, providing incentives to the entity’s customers to make a purchase.

In one embodiment, computer program 125 may also receive historical campaign data from campaign data database 130, merchant data from merchant data database 132, and customer data from customer data database 134.

Campaign data database 130 may store historical data on past campaigns.

Merchant data database 132 may store information on the merchant with which a user is associated, such as products, historical customer engagement levels, etc. The user may be a client or a customer of the entity that provides computer program 125 and user computer program 125.

Customer data database 134 may maintain information on potential customers, such as users of a mobile application or a website, including location information (e.g., registered address), engagement history, purchase history, etc.

Computer program 125 may cause incentives, such as offers, to be displayed on user electronic device 110 via user computer program 115. User electronic device 110 may be a computer, a smart device, an IoT appliance, etc. User computer program 115 may be a browser, an application, etc. that may present the offers or incentives to the user. Notably, computer program 125 may be provided by a third party, such as a financial institution, and the incentives may be for a discount, reward points, etc.

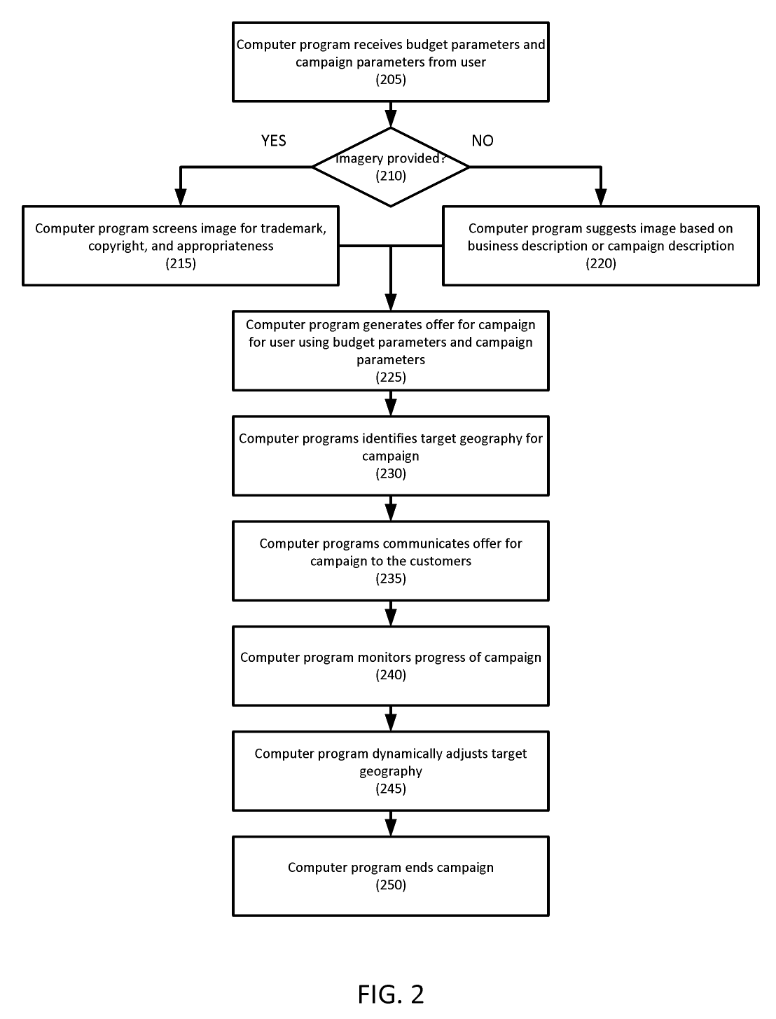

Referring to FIG. 2, a method for campaign management is provided according to an embodiment.

In step 205, a computer program executed by an electronic device may receive, from a merchant electronic device, budget parameters and campaign parameters. The merchant electronic device may be associated with a merchant, such as an owner or an employee.

For example, the computer program may receive a total budget (e.g., dollars), a length of the campaign (e.g., a start date and an end date), an incentive (e.g., 5% cashback, $10 cash back, etc.), a minimum spend amount for the incentive (e.g., $5), a maximum incentive amount (e.g., $20), merchant imagery (e.g., a logo), merchant locations participating in the campaign (e.g., addresses), etc.

In step 210, the computer program may determine whether any imagery, such as a logo for the business, was received. If one was, in step 215, the computer program may screen the image for trademark and/or copyright issues, as well as for appropriateness and image quality. In one embodiment, the computer program may provide the image to a large language model (LLM) and may prompt the LLM to identify any issues.

In one embodiment, a content artificial intelligence (AI) agent may prompt the LLM to identify anything that is inappropriate or offensive the image.

In one embodiment, a copyright AI agent may prompt the LLM to identify any potential copyright issues with the image.

In one embodiment, a trademark AI agent may prompt the LLM to identify any potential trademark issues with the image.

If any issues with the image are identified, a LLM agent may reject the image and ask the merchant to upload another image. Merchants may be given the option to prompt the LLM to modify the image, or to generate an image based on the description of the business and/or parameters for the campaign.

If, in step 210, an image was not provided, in step 220, the computer program may generate an image for the campaign. For example, the marketing AI agent may prompt the LLM to generate an image based on the description of the business and/or parameters for the campaign.

In one embodiment, the marketing AI agent may also prompt the LLM to generate high-quality, contextually relevant lifestyle images for marketing, social media, or campaign use. The images may be tailored to reflect the merchant’s brand, target audience, and campaign goals.

In step 225, the computer program may generate an offer for the campaign using the information received from the merchant. For example, using the parameters received from the merchant, the computer program may analyze the average transaction value (ATV) for specific products or services, and may then evaluate the effectiveness of proposed campaign incentives (such as a 5% cashback with a $10 maximum reward). If the incentive is disproportionately low compared to the ATV, the system predicts low campaign engagement and recommends alternative strategies, such as increasing the incentive. The computer program may also automatically populate / suggest offer approaches based on those same customer insight-like analyses (e.g., you should consider increasing both your cash back percentage and the maximum cash back amount, especially since your average order value (AOV) is high), etc.

In one embodiment, the computer program may leverage a database of historical campaign data to identify the incentive structures that have been most successful for similar products, price points, business types, and locations. This enables data-driven recommendations tailored to the merchant’s context.

In one embodiment, the computer program may update the campaign parameters based on the successful incentive structure(s).

The computer program may return the most popular or effective campaign options, or custom recommendations based on their business profile and geographic location. This personalization increases the likelihood of campaign success and merchant satisfaction.

In step 230, the computer program may also identify a target geography for the campaign. When the merchant provides its ZIP code for the merchant location, the computer program may automatically recommend neighboring customer areas, such as neighboring ZIP codes, to include, optimizing campaign effectiveness. For example, the computer program may dynamically include or exclude adjacent customer areas codes for campaign targeting, based on real-time and historical data such as popularity, activation, and redemption rates. The computer program may consider population density, consumer travel patterns, etc. For example, urban areas may receive tighter targeting, while less dense regions will receive broader targeting.

In one embodiment, the computer program may calculate a search radius based on the merchant’s location (e.g., the merchant’s ZIP code), designated marketing areas, and population. For example, a dense/urban area may have a search radius of 1 mile; a mid-density area, such as a suburb, may have a search radius of between 3 and 10 miles; and a rural area may a search area with up to a 25 mile radius.

Using the calculated search radius, the computer program may identify customers to target (e.g., cardholders residing in the customer areas (e.g., ZIP codes) within the search radius).

In one embodiment, the computer program may incorporate machine learning models to optimize customer area selection dynamically, using historical data on offer impressions, activations, and redemptions. The machine learning models may learn which customer area yields the highest engagement and redemption rates, adjusting future campaigns accordingly.

In another embodiment, the merchant may specify a feature of its target audience, such as commuters between two areas, and may identify the customers to target based on, for example, customer transactions. The merchant may provide an input describing the specific use case (e.g., “target commuters from customer area A to customer area B), and the computer program may incorporate those parameters into its search to identify customers with transaction patterns or whose home/work customer areas (e.g., ZIP codes) match the specified commuter flow.

As an illustrative example, if a customer resides in Greenwich, Connecticut and makes purchases in New York City during the workday, the computer program may identify the customer as a commuter, and may target this customer for a commuter-targeted offer, such as coffee at a transportation hub (e.g., Grand Central Station).

In step 235, the computer program may communicate the offer for the campaign to those customers. For example, the computer program may populate an offer section with for the website with the offer for the campaign.

In step 240, the computer program may monitor the progress of the campaign. For example, the computer program may receive information on views and clicks on the offer on the website, as well as redemptions. The computer program may also monitor subsequent activities by customers that viewed, clicked on, or redeemed the offer.

For example, the computer program may record each offer impression (e.g., how many cardholders viewed the offer), offer activation (e.g. how many clicked to activate the offer (by clicking on the “+”sign next to the offer), and offer redemption (e.g., how many completed a qualifying transaction) using cardholder data. For each redemption, the cardholder’s billing ZIP code, and not the store location, may be stored in the database.

In step 245, the computer program may dynamically adjust the target geography for the campaign based on the monitoring. For example, the computer program may continuously refine the search area and the targeted customer area for card-linked offer campaigns by leveraging real transaction and engagement data.

By analyzing the distribution of customer billing ZIP codes for transactions at a given merchant (using the merchant’s merchant identifier), the computer program may identify the top customer area where customers actually reside. For example, 30% of transactions may come from customers whose billing ZIP matches the merchant’s location, with the top 10 customer area ranked by transaction volume.

The computer program may use the budget and the distribution to dynamically adjust the campaign. For example, if a campaign is running “hot” (e.g., 70% of the budget is spent quickly), the computer program may automatically narrow the target area to customer area closer to the store, focusing on the most responsive audiences.

Conversely, if engagement is low, the computer program may expand the target geography to include more distant customer area.

In one embodiment, the computer program may proactively notify merchants if their campaign is performing exceptionally well and will be expected to exhaust its budget earlier than expected. For example, when the merchant has used up around 90% of their budget, the computer program may prompt the merchant to consider increasing its budget by 10–20%. The computer program may also provide an estimate of the additional value this increase could generate, helping the merchant make an informed decision and maximize their campaign’s success.

In step 250, when the budget is exhausted, or the end date is reached, the computer program may end the campaign.

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field- Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications, or equivalent arrangements.

What is claimed is:

1. A method, comprising:
receiving, by a computer program executed by an electronic device, campaign parameters and a campaign budget for a campaign from a user for a merchant;
generating, by the computer program, an offer for the campaign using the campaign parameters and merchant information;
identifying, by the computer program, a target geography for the campaign;
identifying, by the computer program, targeted customers in the target geography;
populating, by the computer program, an offer section in a website presented to the targeted customers with the offer for the campaign;
monitoring, by the computer program, a progress of the campaign;
dynamically updating, by the computer program, the target geography based on the progress of the campaign; and
terminating, by the computer program, the campaign in response to a campaign term ending or one of the campaign parameters being met.

2. The method of claim 1, wherein the campaign parameters comprise a length of the campaign, an inventive, a minimum spend amount, and a maximum incentive amount.

3. The method of claim 1, further comprising:
receiving, by the computer program, imagery for the campaign from the user;
verifying, by the computer program and using an artificial intelligence (AI) agent, that the imagery is not offensive and does not have copyright or trademark issues; and
in response to the imagery being not offensive and not having copyright or trademark issues, using the imagery in the campaign.

4. The method of claim 1, further comprising:
generating, by the computer program and using a marketing AI agent, imagery for the campaign using the campaign parameters and the merchant information.

5. The method of claim 2, wherein the step of generating the offer for the campaign using the campaign parameters and merchant information comprises:
identifying, by the computer program, an incentive structure that has been successful from a database of historical campaign data for similar merchants; and
updating, by the computer program, the campaign parameters based on the incentive structure.

6. The method of claim 1, wherein the step of identifying the target geography for the campaign comprises:
calculating, by the computer program, a search radius based on a merchant location and a population density; and
automatically adding or excluding, by the computer program, customer areas based on historical activation rates and historical redemption rates.

7. The method of claim 6, wherein the step of identifying the targeted customers in the target geography comprises:
identifying customers with transaction patterns matching a use case specified by the user.

8. The method of claim 1, wherein the step of monitoring the progress of the campaign comprises:
receiving, by the computer program, information on offer views, offer activations, and offer redemptions.

9. The method of claim 8, wherein the step of dynamically updating the target geography based on the progress of the campaign comprises:
dynamically refining, by the computer program, the target geography by adding or removing customer areas based on offer views, offer activations, and offer redemptions in the customer areas.

10. A system, comprising:
a computer program executed by a backend electronic device;
a merchant computer program executed by a merchant electronic device for a merchant; and
a user electronic device executing a user computer program;
wherein:
the computer program is configured to receive from the merchant computer program, campaign parameters and a campaign budget for a campaign from a user for a merchant;
the computer program is configured to generate an offer for the campaign using the campaign parameters and merchant information;
the computer program is configured to identify a target geography for the campaign;
the computer program is configured to identify targeted customers in the target geography;
the computer program is configured to identify populate an offer section in in the user computer program with the offer for the campaign;
the computer program is configured to monitor a progress of the campaign;
the computer program is configured to dynamically update the target geography based on the progress of the campaign; and
the computer program is configured to terminate the campaign in response to a campaign term ending or one of the campaign parameters being met.

11. The system of claim 10, wherein the campaign parameters comprise a length of the campaign, an inventive, a minimum spend amount, and a maximum incentive amount.

12. The system of claim 10, wherein the computer program is further configured to receive imagery for the campaign from the user, to verify using an artificial intelligence (AI) agent, that the imagery is not offensive and does not have copyright or trademark issues, and, in response to the imagery being not offensive and not having copyright or trademark issues, use the imagery in the campaign.

13. The system of claim 10, wherein the computer program is further configured to generate, using a marketing AI agent, imagery for the campaign using the campaign parameters and the merchant information.

14. The system of claim 11, wherein the computer program is configured to generate the offer for the campaign using the campaign parameters and merchant information by:
identifying an incentive structure that has been successful from a database of historical campaign data for similar merchants; and
updating the campaign parameters based on the incentive structure.

15. The system of claim 10, wherein the computer program is configured to identify the target geography for the campaign by:
calculating a search radius based on a merchant location and a population density; and
automatically adding or excluding customer areas based on historical activation rates and historical redemption rates.

16. The system of claim 15, wherein the computer program is configured to identify the targeted customers in the target geography by identifying customers with transaction patterns matching a use case specified by the user.

17. The system of claim 10, wherein the computer program is configured monitor the progress of the campaign by:
receiving information on offer views, offer activations, and offer redemptions.

18. The system of claim 17, wherein the computer program is configured to dynamically update the target geography based on the progress of the campaign by:
dynamically refining the target geography by adding or removing customer areas based on offer views, offer activations, and offer redemptions in the customer areas.

19. A non-transitory computer readable storage medium, including instructions stored thereon, which when read and executed by one or more computer processors, cause the one or more computer processors to perform steps comprising:
receiving campaign parameters and a campaign budget for a campaign from a user for a merchant, wherein the campaign parameters comprise a length of the campaign, an inventive, a minimum spend amount, and a maximum incentive amount;
generating an offer for the campaign using the campaign parameters and merchant information by:
identifying an incentive structure that has been successful from a database of historical campaign data for similar merchants; and
updating the campaign parameters based on the incentive structure;
identifying a target geography for the campaign;
identifying targeted customers in the target geography by:
calculating a search radius based on a merchant location and a population density; and
automatically adding or excluding customer areas based on historical activation rates and historical redemption rates;
populating an offer section in a website presented to the targeted customers with the offer for the campaign;
monitoring a progress of the campaign by receiving information on offer views, offer activations, and offer redemptions;
dynamically updating the target geography based on the progress of the campaign by dynamically refining the target geography by adding or removing customer areas based on offer views, offer activations, and offer redemptions in the customer areas; and
terminating the campaign in response to a campaign term ending or one of the campaign parameters being met.

20. The non-transitory computer readable storage medium of claim 19, further including instructions stored thereon, which when read and executed by the one or more computer processors, cause the one or more computer processors to perform steps comprising:
receiving imagery for the campaign from the user;
verifying, using an artificial intelligence (AI) agent, that the imagery is not offensive and does not have copyright or trademark issues; and
in response to the imagery being not offensive and not having copyright or trademark issues, using the imagery in the campaign.
